(19) United States
(12) Patent Application Publication
(10) Pub. No.: US 2017/0131132 A1
(43) Pub. Date: May 11, 2017

(54) METHOD OF DETERMINING A VOLUME OF LIQUID IN A RESERVOIR FACTORING IN INCLINATION OF THE RESERVOIR

(71) Applicant: TITAN LOGIX CORP, Edmonton (CA)

(72) Inventor: Nolan SERINK, Edmonton (CA)

(21) Appl. No.: 15/318,634

(22) PCT Filed: Jun. 15, 2015
(86) PCT No.: PCT/CA2015/000384

§ 371 Date: Dec. 13, 2016

Related U.S. Application Data
(60) Provisional application No. 61/013,023, filed on Dec. 12, 2007.

(30) Foreign Application Priority Data
Jun. 13, 2014 (CA) 2854287

(51) Int. Cl. G01F 25/00; G01F 23/14; G01F 22/02; G01F 23/00

(52) U.S. Cl. CPC G01F 25/0061; G01F 23/0076; G01F 23/14; G01F 22/02

(57) ABSTRACT

The method of determining the volume includes associating measured values to a volume based on calibration data. The calibration data can be produced by obtaining reservoir geometry data including coordinates of an internal wall surface and a level measurement path in a reservoir reference; obtaining a set of parameters including at least liquid level along the level measurement path and inclination of the reservoir reference relative to a first horizontal axis; for each parameter of the set, obtaining a plurality of incremental values along a corresponding range of values; and producing calibration data by calculating a matrix of liquid volume values based on the reservoir geometry data for each incremental value combination across the ranges of values of all the parameters.

### FIELD

The improvements generally relate to the field of measuring a liquid volume.

### BACKGROUND

Several applications can require precise measurement of a liquid volume in a reservoir. Typically, it is not the volume which is measured by the sensors, but rather a liquid level. The liquid level is representative of the volume, for a known reservoir geometry, when the reservoir is in a reference horizontal plane, but the extrapolated volume value can be biased as a function of several factors, such as inclination of the reservoir relative to the horizontal plane, for instance.

Tanker trucks, for instance, can require precise measurement of a quantity of gasoline and/or chemicals delivered, for instance, which can be determined by subtracting the remaining volume from the initial volume. If the tanker truck or trailer is inclined during delivery, the determined volume can be biased. It was found that even a slight inclination of the order of 1° for instance, can have a perceivable effect on the measured volume.

Henceforth, although existing techniques for measuring a volume of liquid in a tank were satisfactory to a certain degree, there remained room for improvement.

### SUMMARY

In this specification, a system and method are described by which the correlation between liquid level and liquid volume can take into account inclination among a variety of other potential parameters. The system and method can use sensors which provide values of the parameters and a simple processor can be used to associate the sensed values to a corresponding liquid volume value using a calibration data matrix. The calibration data matrix can be produced prior to its use on a tanker truck or other vehicle, using a computer which can take the reservoir geometry data as well as the impact of the parameters into account to produce the matrix. The matrix can then represent a data file of a size better adapted to be stored on a memory accessible by the processor on the vehicle.

In accordance with one aspect, there is provided a method of producing calibration data for use in associating a measured level of liquid in a reservoir to a volume of the liquid in the reservoir factoring in inclination of the reservoir, the method comprising: obtaining reservoir geometry data including coordinates of an internal wall surface and a level measurement path in a reservoir reference; obtaining a set of parameters including at least liquid level along the level measurement path and inclination of the reservoir reference relative to a first horizontal axis; for each parameter of the set, obtaining a plurality of incremental values along a corresponding range of values; and producing calibration data by calculating a matrix of liquid volume values based on the reservoir geometry data for each incremental value combination across the ranges of values of all the parameters.

In accordance with another aspect, there is provided a method for determining a liquid volume in a reservoir, the method comprising: measuring inclination of the reservoir along at least a first horizontal axis; measuring a level of the liquid in the reservoir along a level measurement path; and associating at least the measured inclination value relative to the first horizontal axis and the measured liquid level value to an actual liquid volume value using calibration data, the calibration data comprising a matrix of liquid volume values based on the reservoir geometry data for each incremental value combination across the ranges of values of all the parameters.

In accordance with another aspect, there is provided a system for determining a liquid volume present in a reservoir, the system comprising: a first sensor to measure inclination of the reservoir along a first horizontal axis; a liquid level sensor to determine a level of the liquid in the reservoir along a level measurement path; a memory having calibration data including a liquid volume value associated to each incremental value combination of inclination value along the first horizontal axis and liquid level value along corresponding ranges of all the parameters; and a processor in communication with the first sensor, the liquid level sensor and the memory and operable to associate the measured inclination value and the measured liquid level value to an actual liquid volume value using the calibration data.

Many further features and combinations thereof concerning the present improvements will appear to those skilled in the art following a reading of the instant disclosure.

### DESCRIPTION OF THE FIGURES

In the figures,

FIG. 1 is a block diagram of a first example of a system for determining a liquid volume present in a reservoir in accordance with the present invention;

FIG. 2A is a cross-sectional view of a tanker truck having the system for determining a liquid volume of FIG. 1;

FIG. 2B is an oblique schematic view of the reservoir of the tanker truck of FIG. 2A;

FIG. 2C is a transversal cross-section view taken along lines 2C-2C of FIG. 2B showing an optical liquid level sensor;

FIG. 3A is a transversal cross-sectional view of a tank in accordance with a second embodiment having a pressure-based liquid level sensor; and

FIG. 3B is a transversal cross-sectional view of a tank in accordance with a third embodiment having wire-based liquid level sensor.

### DETAILED DESCRIPTION

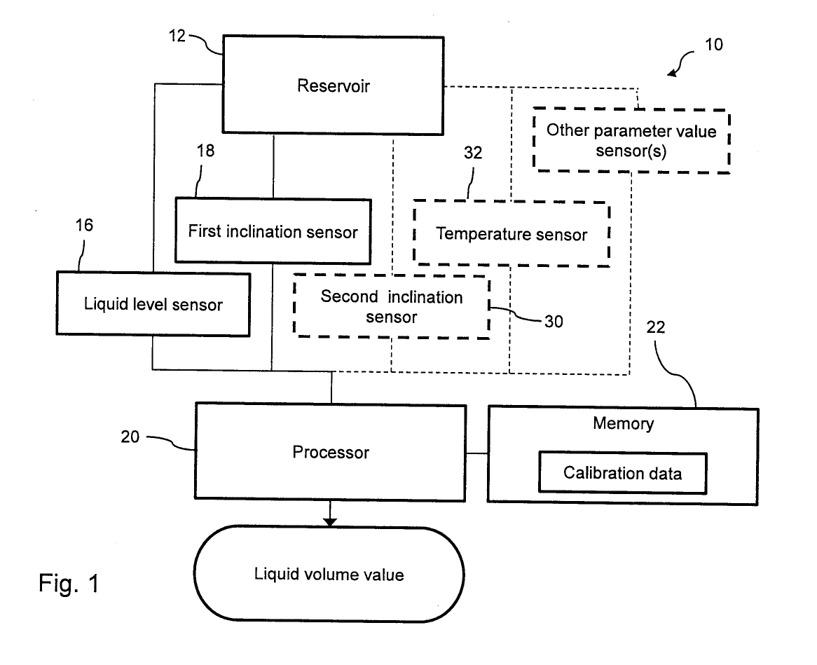

FIG. 1 is a block diagram of a first example of a system 10 for determining a liquid volume present in a reservoir 12 taking into account sensed values of a plurality of parameters such as liquid level, inclination, temperature, etc. To make this determination, a processor 20 of the system can receive the inputs of associated sensors which are representative of actual values of the parameters and can access a calibration data file stored in a memory to associate the sensed values to a specific liquid volume value which takes into account the actual values of the parameters. The calibration data is pre-calculated, as will be exemplified below, and contains a matrix of liquid volume values for each incremental value combination across given ranges of values of all the parameters.

For instance, in this example, the system 10 includes a liquid level sensor 16 and a first inclination sensor 18 which provide instantaneous measurements that can be directly associated, using the processor 20, to an actual liquid value using pre-calculated calibration data factoring in the reservoir geometry data and parameters such as a liquid level value and a first inclination value, for instance. Since the calibration data is pre-calculated using complex algorithms and further stored on a memory 22 connected to the processor 20, the processor used on the vehicle can be of significantly low computational power than the computer used to produce the calibration data. Indeed, the processor 20 can simply have the function of associating the combination of measured values to a corresponding cell of a tabular file, for instance.

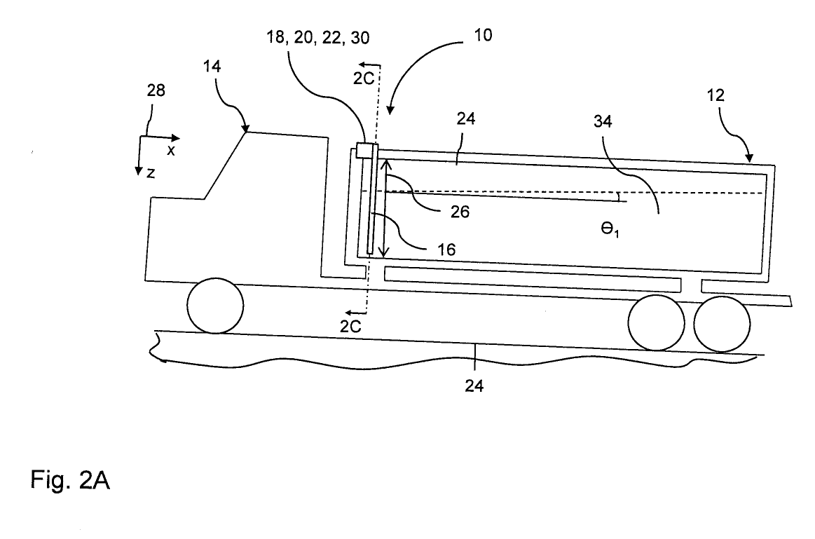

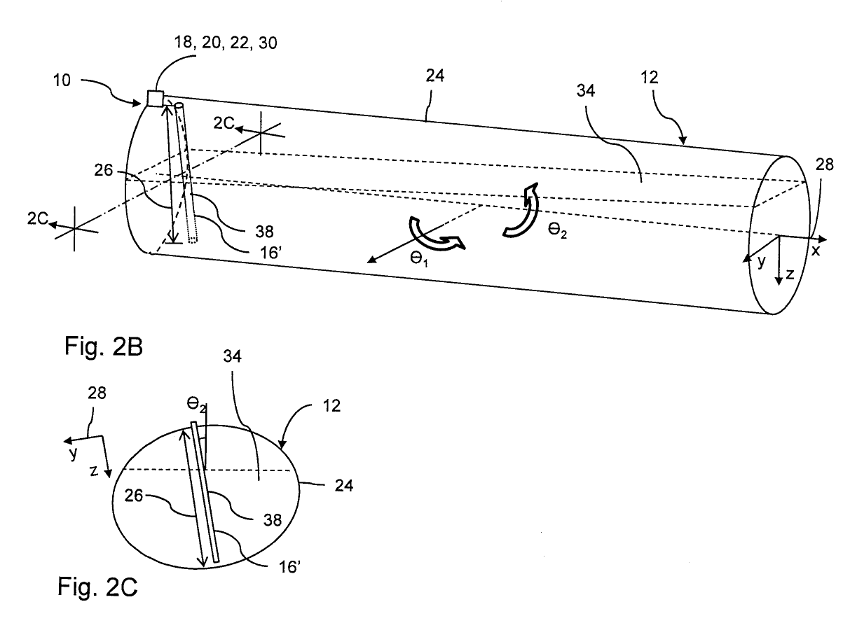

The calibration data can be produced using a three-dimensional (3D) computer-aided design (CAD) program being stored on a memory of a computer (not shown) having a higher computational power. Referring to FIG. 2A, the program can be adapted to obtain reservoir geometry data that can include coordinates of an internal wall surface 24 and coordinates of a level measurement path 26 (the typically rectilinear or curvilinear path along which liquid level is measured) in a reservoir reference 28. For instance, an internal wall surface 24 of the reservoir 12 and a level measurement path 26 can be modelized in 3D using a CAD program. When these are drawn, coordinates of the internal wall surface 24 and of the level measurement path 26 can be obtained relative to the reservoir reference system 28 (e.g. Cartesian, cylindrical, or spherical coordinates as suited to the application). In this specific example, the liquid level sensor 16 shown in the FIG. 2A is a guided wave radar (GWR) having a rectilinear sensing implement, though other liquid sensor types can be used as well as presented below. Although the liquid level sensor 16 is shown in FIG. 1 to be positioned in front of the reservoir 12, it can be also positioned in the middle of the reservoir 12 or at any axial and/or radial position thereof. Moreover, as will be understood from the explanations below, the coordinates of the internal wall surface 23 and the coordinates of the level measurement path 26 are not necessary constant and can vary depending on variation of the values of one or more of the parameters (e.g. to take into account thermal expansion of the reservoir 12 or installation misalignments of the liquid level sensor 16 for instance).

Further, the person skilled in the art can provide a set of parameters to the CAD program. For example, the parameter typically include at least liquid level L along the level measurement path 26 and inclination θ₁ of the reservoir 12 relative to a first horizontal axis “x”. Once the set of relevant parameters for a given application are determined, the CAD program can be provided with a plurality of incremental values along a corresponding range of values for each of the parameters of the set. For instance, a range of liquid level can be between 0.05 m and 0.4 m inclusively while the incremental values may be 0.05 m, 0.010 m, . . . , 0.40 m. Although this example involves an regular increment of 5 mm, it will be understood that the increment can also vary along the range such as by providing a smaller increment in regions of the range where additional precision is deemed relevant. A range of inclination of the reservoir relative to a first horizontal axis can be between −2° to 2° inclusively while the incremental values may be −2°, −1°, . . . , 2°, or −2°, −1.75°, −1.5° . . . , for instance. Once the program is provided with the reservoir geometry data, the incremental values for each of the parameters, it can produce the calibration data in the form of a matrix indicating a liquid volume value taking into consideration the reservoir geometry data (e.g. the coordinates of the internal wall surface 24 and the coordinates of the level measurement path 26) and the parameters (e.g. liquid level and inclination along the first horizontal axis “x”). More specifically, a liquid volume value is calculated for each combination of liquid level value and inclination along the first horizontal axis considering the coordinates of the internal wall surface 24 of the reservoir and the level measurement path 26. Although it is mentioned that the production of the calibration data can be performed through the CAD program, it may alternatively be performed by a plug-in program installed on the memory of a computer, and executable by a CAD program, for instance, or by any other suitable means. Table 1, below, shows an example of calibration data that can be used for known coordinates of internal wall surface 24 and the level measurement path 26.

TABLE 1
Example of calibration data for known coordinates
of the reservoir and the level measurement path

| Liquid volume value | Liquid level L | Inclination Θ₁ |
|---|---|---|
| [m³] | [m] | [°] |
| 0.3242 | 0.05 | −2 |
| 0.3262 | 0.05 | −1 |
| — | 0.05 | . . . |
| 0.3278 | 0.05 | 2 |
| 0.2905 | 0.10 | −2 |
| 0.2923 | 0.10 | −1 |
| — | 0.10 | . . . |
| 0.2948 | 0.10 | 2 |
| — | . . . | — |
| 0.0304 | 0.40 | −2 |
| 0.0294 | 0.40 | −1 |
| — | 0.40 | . . . |
| 0.0304 | 0.40 | 2 |

Once the calibration data is produced by the computer, the calibration data can be stored on the memory 22 connected to the processor 20 that can be provided with the reservoir 12 in order to obtain a liquid volume value rapidly when both the liquid level and the inclination along the first horizontal axis “x” are known.

Accordingly, the liquid level sensor 16 can be connected to the processor 20 and can be adapted to measure the level of liquid along the level measurement path 26 located in the reservoir 12, the first inclination sensor 18 can be connected to the processor 20 and can be adapted to measure a first inclination value indicative of the inclination of the reservoir along a first horizontal axis “x”, and the processor can find the liquid volume value in the matrix illustrated in Table 1 based on the inputs of the sensors.

As detailed above, additional parameters can be taken into account, ranges broadened, or increment reduced, by increasing the size of the matrix. For instance, referring to FIG. 1, the system 10 can have a second inclination sensor 30 being connected to the processor 20 and adapted to measure a second inclination value indicative of the inclination of the reservoir along a second horizontal axis, labeled “y” in FIG. 2B. The first inclination sensor 18 and the second inclination sensor 30 can each be any type of angular sensor, and can be provided in the form of three-axis accelerometers for instance.

For instance, in FIG. 2A, the tanker 14 lays on an inclined plane 36 which impart an inclination θ₁ relative to the first horizontal axis “x”, and an inclination θ₂ relative to the second horizontal axis “y” (as can be seen in FIGS. 2B and 2C). In this example, the first horizontal axis “x” is parallel with a longitudinal axis of the reservoir 12 of the tanker 14. Since the reservoir is incline by an angle θ₁, the liquid in the reservoir moves and reorganizes therewithin. In this example, a first example of the liquid level sensor 16′ is provided in the form of an elongated body 38 which is positioned fixedly along the “z” axis of the reservoir reference 28. In FIG. 2A, the liquid level sensor 16′ is immersed in the liquid, and it measures a liquid level value lower than it would if the tanker 14 were on an horizontal plane. Therefore, the liquid level sensor 16′ can provide the measured inclination along the “x” axis and the measured liquid level to the processor 20 having the memory 22 which can then associated an actual liquid value using the measured inclination and the measured liquid level.

More specifically, it can be seen that the reservoir 12 is inclined also relative the second horizontal axis “y” thus causing the liquid reorganize inside the reservoir. In this example, θ₁ may be −3° while θ₂ may be 5°. Still in this example, the liquid level sensor 16′ has an elongated rectilinear body immersed in the liquid inside the reservoir which is associated to the level measurement path 26 which has fixed coordinates relative to the reference system of the reservoir. Depending on the measured liquid value indicative of the level at which the liquid contacts the liquid level sensor 16′, the processor 20 can associate an actual liquid value to a corresponding value comprised in the calibration data stored on the memory 22 connected to the processor 20.

Moreover, the system 10 can additionally include a temperature sensor 32 connected to the processor 20 and adapted to measure a temperature value of the reservoir 12.

As presented above, the reservoir geometry data (e.g. internal wall surface coordinates, liquid level measurement path coordinates) can vary depending on the parameters. Even though this reservoir geometry data is not necessarily part of the calibration data, its potential variability as a function of given parameter(s) which are part of the calibration data can be taken into consideration during the production of the calibration data.

For instance, the geometry of the reservoir can change as a function of temperature. Accordingly, temperature can be one of the parameters. During the production of the calibration data, the variation of the internal wall surface coordinates due to thermal expansion (the expression thermal expansion being used here as being applicable to contraction or expansion due to temperature change) of the reservoir can be taken into consideration by the CAD software or other suitable means to take the effects of thermal expansion into account in the attribution of a liquid volume value in the matrix. In this sense, with temperature being a parameter for instance, the calibration data matrix will include additional ‘cells’ associated to varying temperature values along the associated temperature ranges, in which case the processor 20 (FIG. 1) can use the additional input of the temperature sensor to find the correct liquid level value in the calibration data then stored on the vehicle.

The geometry of the reservoir can also change as a function of inclination, for instance, given the weight repartition of the liquid contained therein and the associated mechanical distortion on the structure of the reservoir. This also can be taken into account upon producing the calibration data.

In this same line of reasoning, if different liquid types are to be carried by the reservoir, having different densities, or if the effect of temperature variation is considered to have a significant effect on liquid density, for instance, liquid density for a given volume value can have an effect on the weight repartition and thus on the geometry of the reservoir. To account for this, thermally-imparted variations of liquid density can be taken into account at the stage of producing the calibration data, and or, liquid density p can even be included as a further parameter to be included in the set of parameters in the calibration data matrix.

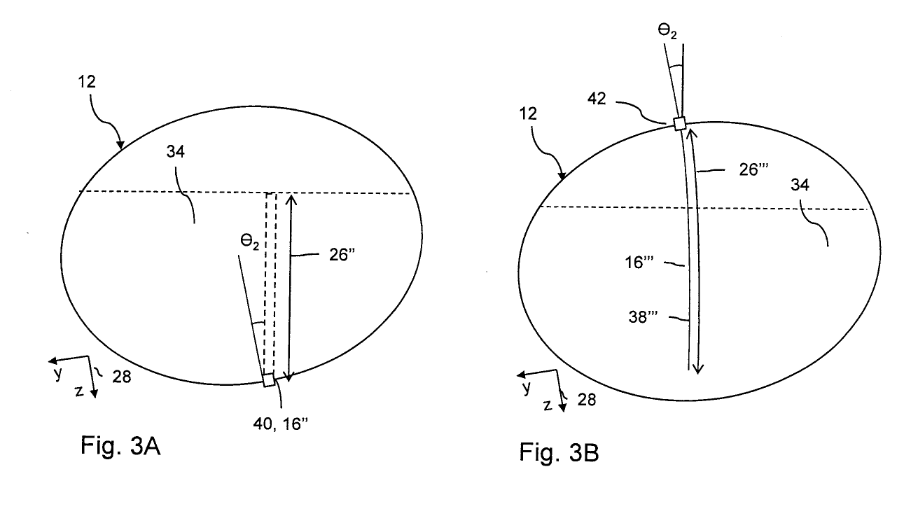

Moreover, as presented above, the liquid level measurement path coordinates can vary depending on the variation of one or more of the parameters. More specifically, depending on the type of liquid level sensor used, coordinates of the level measurement path 26 can be either fixed or variable relative to the reservoir reference. In the detailed example presented above, the liquid level sensor 16 is in the form of a rigid rectilinear tube having a fixed coordinates within the reservoir reference 28. However, in the case of a pressure-based liquid level sensor (see FIG. 3A) or a wire-based liquid level sensor (see FIG. 3B), the coordinates of the liquid level measurement path can also vary significantly in the reservoir reference system depending on the inclination parameters, for instance.

More specifically, FIG. 3A shows a reservoir 12 equipped with a pressure-based liquid level sensor provided at a given location inside the reservoir 12 at a bottom portion 40 thereof. The pressure sensor can provide an indication of liquid level as it measures the pressure exerted by the mass of the liquid above it. In this example, the liquid level measurement path of the pressure-based sensor can be modelized as an upward vertical projection from the location of the pressure sensor, for instance, given the fact that the pressure reading corresponds to the weight of the column of liquid above the sensor. Accordingly, the upward vertical projection will be inclined by the angle θ₂ in the reference system of the tank when the tank, and thus its entire reference system, is inclined at the same angle. For example, if the liquid level sensor 16″ measures a pressure P when the reservoir 12 is not inclined, the liquid level sensor 16″ may measure a pressure 0.95*P when the reservoir 12 is inclined of 5° as shown in FIG. 3A. However, it is not because the liquid level sensor 16″ measures a smaller pressure that it necessarily means that the volume inside the reservoir is smaller. Accordingly, the production of the calibration data can take into account the varying liquid level measurement path coordinates as a function of the varying inclination of the tank to ensure that a given sensed pressure is later associated to a correct liquid volume value independently of inclination of the reservoir within the limit of the associated parameter ranges.

In the other example provided in FIG. 3B, the reservoir is equipped with a wire-based liquid level sensor 16′″ having an elongated flexible body 38′″ along the length of which the gas/liquid interface is sensed. This wire-based sensor is hung from a given location at the upper portion 42 of the reservoir 12 to be partially immersed in the liquid of the reservoir 12 so that when the level of liquid in the reservoir 12 changes, the liquid contacts the liquid level sensor 16′″ at a different linear position along the liquid measurement path 26′″. When the reservoir is perfectly aligned with the horizontal plane, the wire can be vertical and rectilinear. However, if the tank is inclined, the wire can become curvilinear as a function of its weight and its limited elasticity. The change of shape of the wire can be taken into account at the stage or producing the calibration data by correspondingly varying the liquid level measurement path as a function of inclination, for the later accessed calibration data matrix to yield a liquid volume value which takes into account the forces acting on the wire during inclination. Another example of variable liquid level measurement path coordinates can be embodied in a system or method which provides for correction of installation misalignments of the liquid level sensor 16 in the reservoir 12. In this latter example, the variation of liquid level measurement path coordinates as a function of installation misalignment can be provided as a parameter further included in the set of parameters taken into consideration at the stage of producing the calibration data. This can be used to compensate for sensor rotation or misalignment at installation, such as a welded collar fitting that skews normal by 0.5° or a rotated head where the “x” axis of the inclinometer is non-orthogonal to one of the tank's geometric planes, in both of which cases the off value can be inputted as a parameter value in the field or once at installation, to select the correct compensated table of other data values.

As can be understood, the examples described above and illustrated are intended to be exemplary only. For instance, the system and method described herein can be adapted to determine the volume of liquid in vehicles other than tanker trucks and trailers, and can further be adapted for stationary reservoirs. The scope is indicated by the appended claims.

What is claimed is:

1. A method of producing calibration data for use in associating a measured level of liquid in a reservoir to a volume of the liquid in the reservoir factoring in inclination of the reservoir, the method comprising:
obtaining reservoir geometry data including coordinates of an internal wall surface and a level measurement path in a reservoir reference;
obtaining a set of parameters including at least liquid level along the level measurement path and inclination of the reservoir reference relative to a first horizontal axis;
for each parameter of the set, obtaining a plurality of incremental values along a corresponding range of values; and
producing calibration data by calculating a matrix of liquid volume values based on the reservoir geometry data for each incremental value combination across the ranges of values of all the parameters.

2. The method of claim 1, wherein said obtaining a set of parameters further comprises obtaining an inclination of the reservoir reference relative to a second horizontal axis, the second horizontal axis being orthogonal to the first horizontal axis.

3. The method of claim 1, wherein said set of parameters further includes temperature, wherein in said step of producing calibration data, the internal wall surface coordinates vary depending of temperature as a function of thermal expansion.

4. The method of claim 1, wherein said level measurement path coordinates vary depending on variation of at least one of said parameters.

5. The method of claim 4, wherein said level measurement path is an upward vertical projection of a pressure sensor provided at a given location on said internal wall surface of the reservoir geometry data; and wherein said producing calibration data factors in said variation of said level measurement path as a function of variation of at least inclination of the reservoir reference relative to the first horizontal axis.

6. The method of claim 1, wherein said set of parameters includes density of the liquid, wherein the internal wall surface coordinates vary depending of density and volume as a function of structural distortion imparted by weight.

7. The method of claim 1, wherein the level measurement path coordinates are constant.

8. The method of claim 1, wherein said set of parameters includes installation misalignments, wherein the level measurement path coordinates vary depending of the installation of the liquid level sensor in the reservoir.

9. A method for determining a liquid volume in a reservoir, the method comprising:
measuring inclination of the reservoir along at least a first horizontal axis;
measuring a level of the liquid in the reservoir along a level measurement path; and
associating at least the measured inclination value relative to the first horizontal axis and the measured liquid level value to a liquid volume value using calibration data produced by the method of claim 1.

10. A method for determining a liquid volume in a reservoir, the method comprising:
measuring inclination of the reservoir along at least a first horizontal axis;
measuring a level of the liquid in the reservoir along a level measurement path; and
associating at least the measured inclination value relative to the first horizontal axis and the measured liquid level value to an actual liquid volume value using calibration data, the calibration data comprising a matrix of liquid volume values based on the reservoir geometry data for a plurality of incremental value combination across given ranges of values of a plurality of parameters including inclination of the reservoir along at least a first horizontal axis and level of the liquid in the reservoir along a level measurement path.

11. A system for determining a liquid volume present in a reservoir, the system comprising:
a first sensor to measure inclination of the reservoir along a first horizontal axis;
a liquid level sensor to determine a level of the liquid in the reservoir along a level measurement path;
a memory having calibration data including a liquid volume value associated to each incremental value combination of inclination value along the first horizontal axis and liquid level value along corresponding ranges of all the parameters; and
a processor in communication with the first sensor, the liquid level sensor and the memory and operable to associate the measured inclination value and the measured liquid level value to an actual liquid volume value using the calibration data.

12. The system of claim 11 further comprising:
a second sensor to measure inclination of the reservoir along a second horizontal axis, the second horizontal axis being orthogonal to the first horizontal axis;
wherein said calibration data including a liquid value associated to each incremental value combination of inclination value along the first horizontal axis, inclination value along the second horizontal axis and liquid level value along corresponding ranges of all the parameters, and wherein
said processor being connected to the second sensor and adapted to associate the inclination value along the first horizontal axis, the inclination value along the second horizontal axis and the measured liquid level value to an actual liquid volume value using the calibration data.

13. The system of claim 12, wherein the liquid sensor is a pressure sensor provided at a given location on said internal wall surface of the reservoir geometry data, the level measurement path being an upward vertical projection from the given location of the pressure sensor and the liquid level being determined based on the weight of the liquid of the upward vertical projection.

14. The system of claim 12, wherein the liquid level sensor is a wired sensor hung from a given location on said internal wall surface of the reservoir geometry data, the level measurement path being substantially vertically disposed from a base of the wired sensor notwithstanding the inclination of the reservoir.

15. The system of claim 12, wherein the first and second sensors are provided in the form of a single accelerometer.
